(19) United States
(12) Patent Application Publication
(10) Pub. No.: US 2008/0202618 A1
(43) Pub. Date: Aug. 28, 2008

(54) Fiber Reinforced Hose

(75) Inventors: Hideki Shinohara, Komaki-shi (JP); Hiroyoshi Mori, Iwakura-shi (JP); Yoshiki Kodaka, Kasugai-shi (JP)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Tokai Rubber Industries, Ltd., Komaki-shi (JP)

(21) Appl. No.: 12/035,484

(22) Filed: Feb. 22, 2008

(30) Foreign Application Priority Data
Feb. 28, 2007 (JP) 2007-049835

(51) Int. Cl. F16L 11/08

(52) U.S. Cl. 138/126; 138/124

(57) ABSTRACT

A fiber reinforced hose has a multilayer structure including an inner rubber layer, an outer rubber layer and a fiber reinforcing layer of a reinforcing yarn between the inner rubber layer and the outer rubber layer. The reinforcing yarn includes at least one raw yarn. The raw yarn is obtained by fixedly entangling short fibers with multiple monofilaments that are a bundle of paralleled monofilaments so as to intersect with the paralleled monofilaments and project from the multiple monofilaments.

### BACKGROUND OF THE INVENTION

1. Field of the Invention

The present invention relates to a fiber reinforced hose having a fiber reinforcing layer between an inner rubber layer and an outer rubber layer, specifically, to the fiber reinforced hose characterized by the fiber reinforcing layer.

2. Description of the Related Art

Previously, a fiber reinforced hose with a multilayer structure including an inner rubber layer, an outer rubber layer and a fiber reinforcing layer of a reinforcing yarn between the inner rubber layer and the outer rubber layer has been used widely for a hose for an automotive and other applications.

In such a fiber reinforced hose, strength, abrasion resistance, and adhesiveness to the rubber layer of the reinforcing yarn composing the fiber reinforcing layer are important factors that affect pressure resistance, durability and heat resistance of the fiber reinforced hose.

For example, when the strength of the reinforcing yarn is small, the pressure resistance (bursting pressure) of a fiber reinforced hose is low. When the abrasion resistance of the reinforcing yarn is low, the reinforcing yarn is apt to fray by friction between the reinforcing yarns due to repeated pressures and vibrations from a fluid flowing in the hose, namely, a dynamic load acting on the hose, and as a result, durability as well as the pressure resistance are degraded in the hose.

With regard to the adhesiveness of the reinforcing yarn, in particular when the reinforcing yarn is bonded to the rubber layer with an adhesive agent, bonding strength between the reinforcing yarn and the rubber layer is degraded at high temperature since chemical bonding strength of the adhesive agent is lowered at high temperature, and as a result, the reinforcing yarn is peeled from the rubber layer and shifting of the reinforcing yarn is caused under the dynamic load or the like. Consequently, the pressure resistance and the durability of the hose are degraded. Namely, the hose has low heat-resistance.

In the past, for the reinforcing yarn of the reinforced layer of such a fiber reinforced hose, a filament yarn, an adhesive-coated filament yarn, a spun yarn (a staple yarn) and the like have been generally used.

Here, the filament yarn is obtained by twisting strands of a multitude of paralleled long fibers (filaments or monofilaments, for example, about 1000 to 2000 individual monofilaments are provided), and the adhesive-coated filament yarn is obtained by coating a surface of a filament yarn with an adhesive agent.

And, the span yarn is obtained by spinning short fibers (for example, staples) which are drawn from a flocculent mass of fibers into a long continuous yarn.

The filament yarn has a high strength but is not fuzzy. Therefore, when the filament yarn is used in a reinforcing layer of a hose, the reinforcing layer presents difficulties in providing a mechanical integrity (adhesiveness) to a rubber layer. Due to this reason, aforementioned shifting of the filament yarn is apt to be caused when the dynamic load acts on the hose. As a result, there is a problem that the pressure resistance, the durability, and sealing performance of the hose are degraded.

For addressing the above shortcomings of the filament yarn, the adhesive-coated filament yarn is produced by coating a surface of the filament yarn with an adhesive agent so as to provide adhesion to a rubber layer by the adhesive agent.

However, adhesion or bonding force by the adhesive agent highly depends on a temperature. So, when the adhesive-coated filament yarn is used in a fiber reinforcing layer of a hose, the reinforcing layer is apt to peel from a rubber layer at high temperature due to the reason that chemical bonding strength of the adhesive agent is lowered at high temperature. There is a problem that bonding reliability is poor in the hose.

On the other hand, since the spun yarn contains many fuzzes or fluffs, when the spun yarn is used in a reinforcing layer of a hose, the reinforcing layer provides an anchoring effect in a rubber layer (the fuzzes are embedded in the rubber layer). Therefore, the reinforcing layer easily provides a mechanical integrity (adhesiveness) to the rubber layer. However, the spun yarn does not consist of a single continuous fiber (filament), but just a single yarn of interlocked or twisted short fibers. So, the spun yarn has low tensile strength.

For increasing tensile strength of the reinforcing yarn, the spun yarn should be formed thick.

As stated, the above reinforcing yarns of the filament yarn, the adhesive-coated filament yarn and the spun yarn have problems, respectively. So, Patent Document 1 as below discloses a reinforcing yarn that is obtained by artificially fuzzing a filament yarn. The reinforcing yarn of Patent Document 1 is called a spunized yarn. The spunized yarn is obtained in a following manner. A multitude of paralleled monofilaments are bundled into a bundle, a tensile force is applied to the bundle of the monofilaments to cut or stretch-break (stretch-cut) each of the monofilaments at an arbitrary position into a length of about 60 cm. Then the monofilaments are twisted together into a spunized yarn. The spunized yarn is provided with fuzzes as predetermined in a procedure of stretch-break of the monofilaments.

The spunized yarn has advantages of both the filament yarn and the spun yarn. However, since the spunized yarn is obtained by stretch-break of each of the monofilaments of the filament yarn at the arbitrary position, needless to say, the spunized yarn is inferior to the filament yarn in strength. Therefore, a fiber reinforced hose including the spunized yarn is inferior to a fiber reinforced hose including the filament yarn and a fiber reinforced hose including the adhesive-coated filament yarn in pressure resistance.

And, the spunized yarn is fabricated from limited fiber materials that are suitable for being spunized (stretch-broken or stretch-cut). For example, a polyester monofilament or yarn is very elastic. When tensile force is applied to the polyester monofilament, the polyester monofilament is elastically elongated largely and cannot be stretch-broken or stretch-cut. So, the polyester monofilament is not suitable for being spunized. And, it is also difficult to spunize fibers such as metal fiber and glass fiber.

In recent years, more enhanced heat-resistance, more enhanced pressure resistance, and the like have been increasingly demanded for a hose for an automotive, etc. Actually, conventional fiber reinforced hoses have difficulties to fully meet the demands.

[Patent Document 1] U.S. Pat. No. 6,994,119

Under the foregoing circumstances, it is an object of the present invention to provide a fiber reinforced hose having enhanced heat-resistance, enhanced pressure resistance, and enhanced durability compared to conventional fiber reinforced hoses.

### SUMMARY OF THE INVENTION

According to the present invention, there is provided a novel fiber reinforced hose. The fiber reinforced hose comprises a multilayer structure including an inner rubber layer, an outer rubber layer and a fiber reinforcing layer of a reinforcing yarn or reinforcing yarns between the inner rubber layer and the outer rubber layer. The reinforcing yarn includes at least one raw yarn of a filament yarn. The raw yarn or the filament yarn comprises multiple monofilaments (individual long fibers) that are a bundle of paralleled monofilaments and short fibers (for example, staples) that are fixedly entangled with the multiple monofilaments so as to intersect with the paralleled monofilaments and project from the multiple monofilaments, more specifically, project laterally from the multiple monofilaments.

According to one aspect of the present invention, the fiber reinforcing layer of the fiber reinforced hose is fabricated with use of at least one raw yarn of the filament yarn obtained by entangling the short fibers with the multiple monofilaments and twisting the multiple monofilaments so as to fix the short fibers with the multiple monofilaments.

The filament yarn (the raw yarn) with which the short fibers are entangled is fluffy or fuzzy. The filament yarn may be made as fuzzy as desired by increasing an amount of the short fibers entangled with the filament yarn. Unlike in the spunized yarn, the monofilaments are not required to be stretch-broken, thus strength of the filament yarn is not degraded.

Therefore, the raw yarn with which the short fibers are entangled can sufficiently enhance mechanical unification (adhesiveness) to the rubber layer thanks to an anchoring effect provided by fuzzes or hairiness. And, since the raw yarn comprises the multiple monofilaments that are not stretch-broken, the raw yarn has a high strength inherent in a filament yarn. Therefore, the fiber reinforced hose is provided with higher pressure resistance, higher abrasion resistance, and higher heat resistance than before by fabricating the fiber reinforcing layer from the raw yarn.

And, according to the present invention, for the fiber reinforcing layer, any fiber material or member such as polyester, a metal fiber or a grass fiber may be used. Namely, the present invention also provides an advantage that there exists no restraint in choice of the fiber material or member for the fiber reinforcing layer.

According to one aspect of the present invention, the short fibers are fixedly entangled with the multiple monofilaments so as to be perpendicular or generally perpendicular to the paralleled monofilaments, thereby the raw yarn may be made fuzzy sufficiently to provide the good anchoring effect of the fiber reinforcing layer to the rubber layer.

According to one aspect of the present invention, the short fibers have length of 55 mm or shorter. The length of the short fiber equal to 55 mm or shorter facilitates entangling of the short fiber with the filament yarn. And, the short fibers have length of 3 mm or longer. The length of the short fiber equal to 3 mm or longer ensures the anchoring effect.

Now, the preferred embodiments of the present invention will be described in detail with reference to the drawings.

### BRIEF DESCRIPTION OF THE DRAWINGS

FIG. 1A is a perspective view showing a multilayer structure of a fiber reinforced hose of one embodiment according to the present invention.

FIG. 1B is a perspective view showing another multilayer structure different from that of FIG. 1.

FIG. 2 is a schematic view showing a process of fabricating a reinforcing yarn.

### DETAILED DESCRIPTIONS OF THE PREFERRED EMBODIMENTS

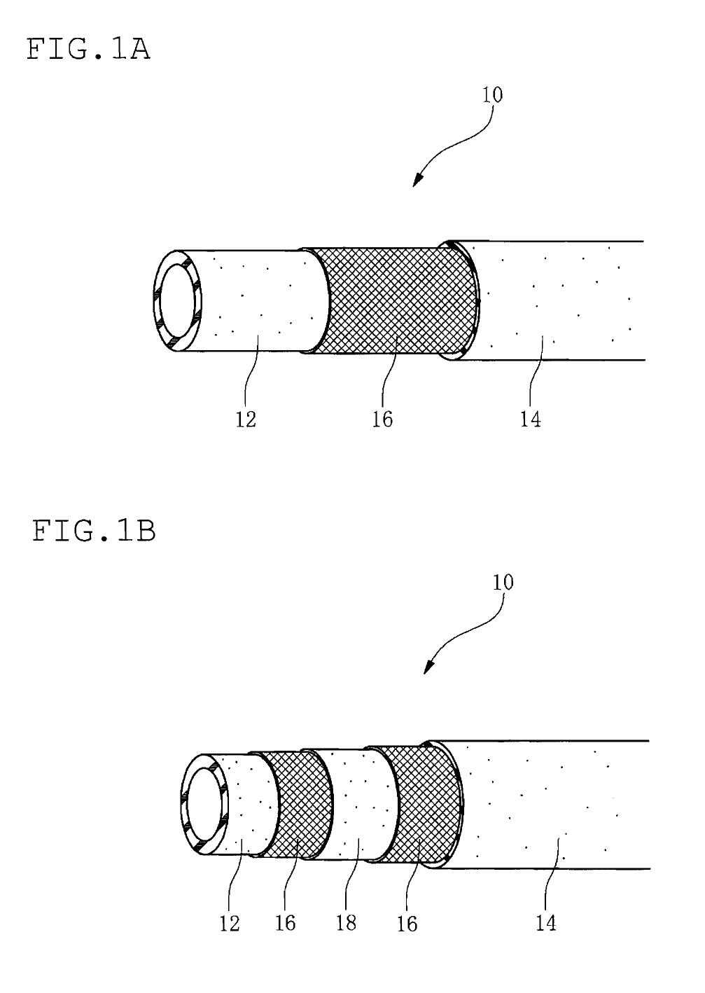

In FIG. 1, numeral reference 10 indicates a fiber reinforced hose of the present embodiment. The fiber reinforced hose 10 comprises a multilayer structure including an inner rubber layer 12, an outer rubber layer 14 and a fiber reinforcing layer 16 between the inner rubber layer 12 and the outer rubber layer 14.

Here, the fiber reinforced hose 10 may include one or more than one inner rubber layers 12, and one or more than one outer rubber layers 14, respectively.

The fiber reinforcing layer 16 is fabricated by braiding a reinforcing yarn. However, the fiber reinforcing layer 16 may be fabricated in any other manner. For example, the reinforcing yarn may be spirally wound, or knitted to fabricate the fiber reinforcing layer 16.

And, the fiber reinforced hose 10 may include one or more than one fiber reinforcing layers 16. When more than one fiber reinforcing layers 16 are provided, a middle rubber layer is disposed between the fiber reinforcing layers 16.

FIG. 1B is a view showing that two fiber reinforcing layers 16 are provided and the middle rubber layer 18 is interposed between the fiber reinforcing layers 16.

In order to provide the fiber reinforced hose 10 with a specific function, a functional layer with the specific function, for example, a fluid barrier layer such as a resin layer or a metal film layer can be formed as an inner surface layer inside the inner rubber layer 12 or in any other arbitrary positions in a thickness direction of the fiber reinforced hose 10.

The fiber reinforced hose 10 of this embodiment may be used for various applications. For example, the fiber reinforced hose 10 may be used for an air hose of an automobile, a heater hose of an automobile, an oil hose of an automobile, or an air-conditioner hose of an automobile that requires heat resistance as well as pressure resistance and the durability, or hoses for various industrial applications.

In particular, the fiber reinforced hose 10 of this embodiment is suitable as a hose for conveying a fluid of a high-temperature air, for example, of about 170° C.

According to the application, for the inner rubber layer 12, various rubber materials such as acrylonitrile-butadiene-rubber (NBR), ethylene-propylene-diene rubber (EPDM), chloroprene rubber (CR), styrene butadiene rubber (SBR), butadiene rubber (IIR), acrylic rubber (ACM), fluoro rubber (FKM), epichlorohydrin-ethylene oxide copolymer (ECO), chlorosulfonated polyethylene (CSM), and silicone (VMQ) rubber may be used. These rubber materials are also applied to the outer rubber layer 14 and the middle rubber layer 18.

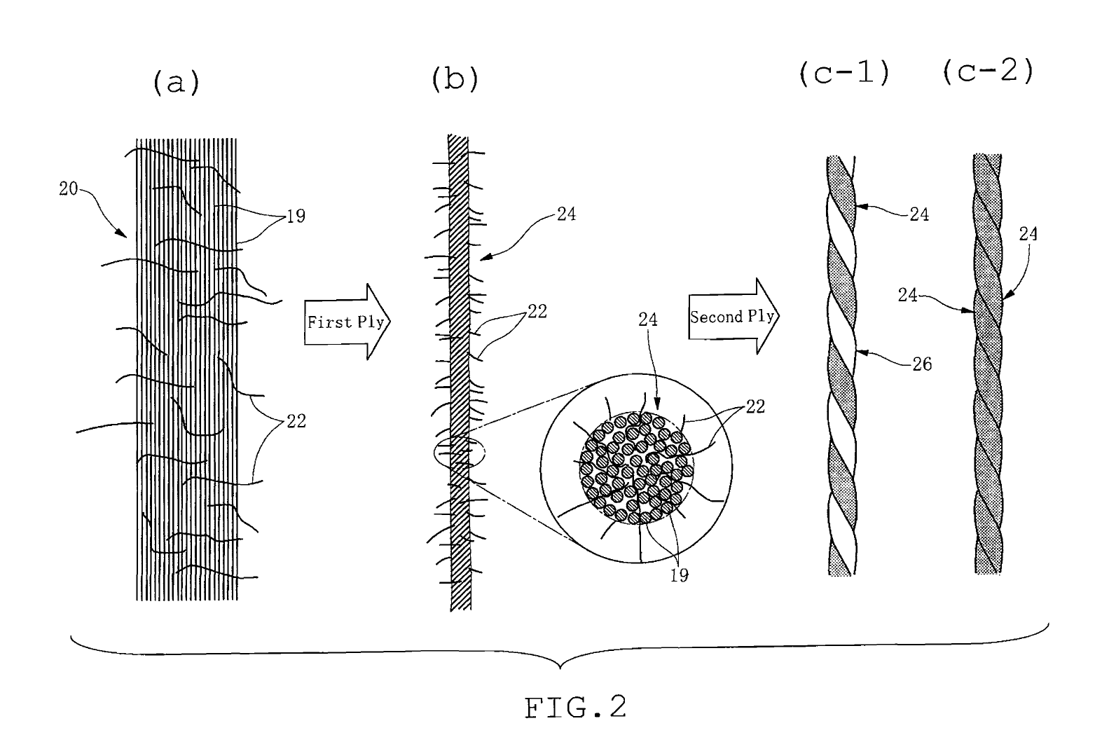

FIG. 2 schematically shows a construction of a reinforcing yarn used in the fiber reinforcing layer 16. In FIG. 2(a) (FIG. 2(a) schematically shows multiple monofilaments with which short fibers are entangled), reference numeral 19 indicates a monofilament, and reference numeral 20 indicates multiple monofilaments that are a bundle of paralleled monofilaments 19. Reference numeral 22 indicates a short fiber or a staple that is entangled with the multiple monofilaments 20 so as to intersect with the paralleled monofilaments 19, for example, so as to be perpendicular or generally perpendicular to an extending direction of the monofilament 19 and so as to project from the multiple monofilaments 19, for example, project laterally from the multiple monofilaments 19. In this embodiment, the multiple monofilaments 20 with which the short fibers 22 are entangled are twisted (fist twist) to fix the short fibers 22 in the multiple monofilaments 20, thereby a raw yarn or filament yarn 24 is obtained. The fiber reinforcing layer 16 is fabricated from the raw yarn 24.

In this embodiment, for the monofilament 19, polyethylene terephthalate (PET), polyethylene naphtahalate (PEN), aromatic polyarnide, namely aramid, polyphenylensulfid (PPS), polyparaphenylene benzobisoxazole (PBO), polytetrafluoroethylene (PTFE), polyallylate, glass fiber, metal fiber, carbon fiber, or other fiber materials may be used. These fiber materials are also applied to the short fiber 22.

A length of the short fiber 22 is preferably in a range of 3 mm to 55 mm. When the length of the short fiber 22 is shorter than 3 mm, it is difficult to fix the short fiber 22 in the filament yarn 24. On the other hand, when the length of the short fiber 22 is longer than 55 mm, it is difficult to entangle the short fiber 22 with the filament yarn 24.

More preferably, the length of the short fiber 22 is in a range of 5 mm to 30 mm.

A length of the short fiber 22 projecting from the raw yarn 24 (length of a fuzz) is preferably 1 mm or longer. An amount or quantity of the short fiber 22 with such a length to be entangled with the filament yarn 24 is preferably 500 to 5000 per unit length of 10 m of the raw yarn 24 (the amount is hereinafter referred to as fuzz-index).

When the fuzz-index is smaller than 500, the fiber reinforcing layer 16 cannot provide a sufficient mechanical unification or integrity to the rubber layer 12, 14 or 18. When the fuzz-index is greater than 5000, it is difficult to fabricate the raw yarn 24.

The fuzz-index is stated also in JP-A-2004-169223, and may be measured by F-INDEX TESTER commercially available from Shikibo Ltd.

The short fibers 22 are entangled with the multiple monofilaments 20 as shown in FIG. 2(a) in the following manner. The short fibers 22 are penetrated in the multiple monofilaments 20 that are loosened by blowing an air containing the short fibers 22 laterally against the multiple monofilaments 20, thereby the short fibers 22 are entangled with the multiple monofilaments 20. Or, the multiple monofilaments 20 are passed through a layer that is filled with the short fibers 22, thereby the short fibers 22 are entangled with the multiple monofilaments 20. Any other suitable manners can be used to entangle the short fibers 22 with the multiple monofilaments 20.

And, here the multiple monofilaments 20 with which the short fibers 22 are entangled are twisted (first ply) to obtain the raw yarn 24 of FIG. 2(b) at a certain twist number. The twist number is set preferably such that a ply index X defined in the following formula is in a range of 2 to 6. When the twist number of the first ply is set such that the ply index X is smaller than 2, the short fibers 22 are not fixed sufficiently in the multiple monofilaments 20. On the other hand, when the twist number of the first ply is set such that the ply index X is greater than 6, the raw yarn 24 does not have sufficient tensile strength.

$$X = \frac{Twist Number ( twist \text{/} meter ) \times \sqrt{Degree of Fitness ( denier )}}{2880} \qquad Formula ( 1 )$$

Meanwhile, in the formula (1), “twist number” means the number of twist per unit length (1 m) of a raw yarn (first ply), and “degree of fineness” is the fineness of the raw yarn (first ply) expressed in denier.

And, the denominator “2880” is a constant number based on the experimental rule.

In this embodiment, the fiber reinforcing layer 16 may be fabricated from the reinforcing yarn of the single raw yarn 24. Or, the fiber reinforcing layer 16 also may be fabricated from the reinforcing yarn that is obtained by twisting the raw yarn 24 with other yarn or yarns (second ply or final ply) in order to meet required strength.

In the latter case, the reinforcing yarn may be obtained by twisting two yarns, or more than two yarns for the second ply.

For the second ply, two of the raw yarns 24 of FIG. 2(b) may be twisted to obtain the reinforcing yarn (two-ply yarn, the reinforcing yarn as shown in FIG. 2(c-2). Or, for the second ply, the raw yarn 24 may be twisted with a filament yarn 26 with which the short fiber 22 is not entangled to obtain the reinforcing yarn as shown in FIG. 2(c-1).

In any case, in the present embodiment, the reinforcing yarn includes at least one raw yarn 24 with which the short fibers 22 are entangled. Meanwhile, characteristics of the two-ply yarn, etc. depend on the twist number of the first ply or the ply index X of the first ply, but do not depend on a twist number (twist/meter) of the second ply or a degree of fineness (denier) of the second ply.

### Example

Table 1 shows examples and comparison examples of the fiber reinforced hose 10 that are prepared by varying structures.

TABLE 1

| | | Example 1 | Example 2 | Example 3 | Example 4 |
|---|---|---|---|---|---|
| Rubber | Inner rubber | ACM | ACM | ACM | ACM |
| layers | layer | | | | |
| | Outer rubber | ACM | ACM | ACM | ACM |
| | layer | | | | |
| Reinforcing | Material of | Aramid | Aramid | PEN | PBO |
| yarn | monofilament | | | | |
| | Fineness of | 1.5 | 1.5 | 1.8 | 1.7 |
| | monofilament | | | | |
| | (denier) | | | | |
| | Material of short | Aramid | PET | Aramid | Aramid |
| | fiber | | | | |
| | Fineness of short | 1.5 | 2 | 1.5 | 1.5 |
| | fiber (denier) | | | | |
| | Length of short | 20 | 20 | 20 | 20 |
| | fiber (mm) | | | | |
| | Fineness of raw | 1000 | 1000 | 1000 | 1000 |
| | yarn (denier) | Single yarn | Single yarn | Single yarn | Single yarn |
| | Ply index of first | 4 | 4 | 4 | 4 |
| | ply | | | | |
| | Ply index of | — | — | — | — |
| | second ply | | | | |
| | Fuzz-index (raw | 1600 | 1100 | 2100 | 2000 |
| | yarn) | | | | |
| | Appearance of | Good | Good | Good | Good |
| | twisted yarn (raw | | | | |
| | yarn) | | | | |
| | | Example 5 | Example 6 | Example 7 | Example 8 |
| Rubber | Inner rubber | ACM | ACM | ACM | ACM |
| layers | layer | | | | |
| | Outer rubber | ACM | ACM | ACM | ACM |
| | layer | | | | |
| Reinforcing | Material of | Polyallylate | Aramid | Aramid | Aramid |
| yarn | monofilament | | | | |
| | Fineness of | 2 | 1.5 | 1.5 | 1.5 |
| | monofilament | | | | |
| | (denier) | | | | |
| | Material of short | Aramid | Aramid | Aramid | Aramid |
| | fiber | | | | |
| | Fineness of short | 1.5 | 1.5 | 1.5 | 1.5 |
| | fiber (denier) | | | | |
| | Length of short | 20 | 20 | 20 | 3 |
| | fiber (mm) | | | | |
| | Fineness of raw | 1000 | 1000 | 1000 | 1000 |
| | yarn (denier) | Single yarn | Single yarn | Single yarn | Single yarn |
| | Ply index of first | 4 | 2 | 6 | 4 |
| | ply | | | | |
| | Ply index of | — | — | — | — |
| | second ply | | | | |
| | Fuzz-index (raw | 800 | 700 | 2300 | 4800 |
| | yarn) | | | | |
| | Appearance of | Good | Good | Good | Good |
| | twisted yarn (raw | | | | |
| | yarn) | | | | |
| | | | | Comparison | Comparison |
| | | Example 9 | Example 10 | Example 1 | Example 2 |
| Rubber | Inner rubber | ACM | ACM | ACM | ACM |
| layers | layer | | | | |
| | Outer rubber | ACM | ACM | ACM | ACM |
| | layer | | | | |
| Reinforcing | Material of | Aramid | Aramid | Aramid | Aramid |
| yarn | monofilament | | | | |
| | Fineness of | 1.5 | 1.5 | 1.5 | 1.5 |
| | monofilament | | | | |
| | (denier) | | | | |
| | Material of short | Aramid | Aramid | — | — |
| | fiber | | | | |
| | Fineness of short | 1.5 | 1.5 | — | — |
| | fiber (denier) | | | | |
| | Length of short | 50 | 30 | — | — |
| | fiber (mm) | | | | |
| | Fineness of raw | 1000 | 800 | 1000 | 1000 |
| | yarn (denier) | Single yarn | two-ply yarn | Single yarn | Single yarn |
| | | | (400 × 2 plies) | | (spunized yarn) |
| | Ply index of first | 4 | 4 | 1 | 1 |
| | ply | | | | |
| | Ply index of | — | 3 | — | — |
| | second ply | | | | |
| | Fuzz-index (raw | 1500 | 1300 | 0 | 2000 |
| | yarn) | | | | |
| | Appearance of | Good | Good | Good | Good |
| | twisted yarn (raw | | | | |
| | yarn) | | | | |

In Table 1, the term “single yarn” means that a reinforcing yarn is a single raw yarn. The term “two-ply yarn” of Example 10 means that a reinforcing yarn is fabricated by twisting two raw yarns 24, each having fineness of 400 deniers.

In the above examples 1 to 10, the raw yarn 24 with which the short fibers 22 are entangled can sufficiently enhance mechanical unification (adhesiveness) with the rubber layer thanks to an anchoring effect provided by short fibers (fuzzes). And, since the raw yarn 24 comprises the multiple monofilaments 19 that are not stretch-broken, the raw yarn 24 has a high strength inherent in a filament yarn. Therefore, the fiber reinforced hose 10 is provided with higher pressure resistance, higher abrasion resistance, and higher heat resistance than before by fabricating the fiber reinforcing layer 16 with the raw yarn 24.

Although the preferred embodiments have been described above, these are only some of embodiments of the present invention. The present invention may be embodied by a variety of modifications without departing from the scope of the invention.

What is claimed is:

1. A fiber reinforced hose, comprising:
a multilayer structure including an inner rubber layer, an outer rubber layer and a fiber reinforcing layer of a reinforcing yarn between the inner rubber layer and the outer rubber layer, the reinforcing yarn including at least one raw yarn of a filament yarn;
wherein the filament yarn comprises:
multiple monofilaments that are a bundle of paralleled monofilaments;
short fibers fixedly entangled with the multiple monofilaments so as to intersect with the paralleled monofilaments and project from the multiple monofilaments.

2. The fiber reinforced hose as set forth in claim 1, wherein the multiple monofilaments are twisted.

3. The fiber reinforced hose as set forth in claim 1, wherein the short fibers are fixedly entangled with the multiple monofilaments so as to project laterally from the multiple monofilaments.

4. The fiber reinforced hose as set forth in claim 1, wherein the short fibers are fixedly entangled with the multiple monofilaments so as to be perpendicular or generally perpendicular to the paralleled monofilaments.

5. The fiber reinforced hose as set forth in claim 1, wherein the short fibers have length of 55 mm or shorter.

6. The fiber reinforced hose as set forth in claim 5, wherein the short fibers have length of 3 mm or longer.
